(19) United States
(12) Patent Application Publication
(10) Pub. No.: US 2006/0266416 A1
(43) Pub. Date: Nov. 30, 2006

(54) Self-locking inflation valve

(76) Inventor: Chih-Ming Chen, Hsintien City (TW)

Correspondence Address: LEONG C LEI, PMB # 1008, 1867 YGNACIO VALLEY ROAD, WALNUT CREEK, CA, 94598, US

(21) Appl. No.: 11/135,421

(22) Filed: May 24, 2005

(51) Int. Cl. F16K 21/00

(52) U.S. Cl. 137/223

(57) ABSTRACT

A self-locking inflation valve works by having an extension inflation tube adapted to an aerator to execute locking in fashion of rotation and insertion to enable the inflation valve of the object to be inflated self-locking and secured type of opening for the object to achieve dual efficacies of inflation or air suction/drain; a mortise being provided in relation to the extension inflation tube on the inner edge of the end of an inflation valve assembly to enable self-locking when the tube being coupled into the mortise to force the inner valve to retreat thus to open up the inflation valve gate; and the inflation valve gate being automatically shut off through a built-in coil once the extension tube clears away from the mortise.

### BACKGROUND OF THE INVENTION

(a) Technical Field of the Invention

The present invention is related to a self-locking inflation valve, and more particularly, to a construction of an inflation valve with a breakthrough of utility.

(b) Description of the Prior Art

Inflation products generally available in the market are usually used in the fields of entertainment, sports and leisure activities with the primary appeal of having the inflated object to provide its specific style as desired without compromising its lightweight and agile operation features for use in water or on land. Therefore, the inflated object may be as small as in the form of a swimming ring or inflated toy or as big as an inflated bed, or inflated boat. An inflation valve is a must to any type of inflated object, and has significant affects upon the quality, service life, and use safety of the inflated object.

As illustrated in FIG. 1 of the accompanying drawings for an inflation valve (A1) of the prior art, it takes manual operation, e.g., kneading, to open up the valve gate. A one-way valve is disposed inside the inflation valve (A1) that is normally in its closed status. Upon inflation (blowing air into the valve by mouth), the one-way valve must be kneaded or pinched to be deformed before delivering the air into the valve or discharging the air by squeezing the inflation object. A folding lid (A2) must be provided to plug the valve due to the poor air-tightness of the inflation valve (A1). Furthermore, the absence of air from a power aerator in earlier time, the inflated object is vulnerable to air leakage and winding up in deflated condition.

With the introduction of the power aerator, the earlier form of inflated object that requires blowing air into it by mouth has already been gradually waived and is not applicable to the larger inflated object currently in fashion. Accordingly, many types of inflation valve constructions have been introduced that provide better air-tightness and applicability to more advanced level of inflated object. However, all currently inflated objects such as the inflated bed or inflated boat have relied on the one-way valve, meaning it takes strong air current to push opening the valve before inflation by consuming more power and electricity of the power aerator to put it always operating at higher pressure load. As a result, the power aerator could easily generate high heat in short time. Furthermore, in the process of inflation, it takes one man to hold the insertion of the valve to maintain continuous inflation due to the absence of the adaptation of a locking (self-locking) air tube from the power aerator to make the process consuming too much time and efforts, inverse air leakage due to increased internal pressure of saturation, and longer inflation time.

### SUMMARY OF THE INVENTION

The primary purpose of the present invention is to provide a self-locking inflation valve to eliminate those flaws found with the prior art while effectively and significantly increasing the range of application by providing the following advantages:

1. Simplified construction of the inflation valve to ensure reliable operation and longer service life for both of the inflated object and the power aerator.

2. Dual purposes of a two-way valve of inflation, and suction/drain simply by use of a locking coil, and the two-way function is automatically created after the self-locking with the tube extended from the aerator to achieve the purpose of fast inflation or fast drain through inverse air suction by the aerator.

3. The arc of a resilient film bowl inserted to where between the valve plug and surface of the valve help ensure the positioning and airtight results of the valve plug while helping even more the fast airflow guide in air circulation.

4. The self-locking mechanism will cause the extension tube of the aerator to be automatically ejected when the tube is rotated to be removed thus to synchronously shut off the valve and completely eliminate the leakage problem due to deferred operation.

5. The self-locking mechanism also secures the extension tube of the aerator to prevent the tube from being retreated by the inverse pressure resulted from the inner pressure air current.

6. The self-locking mechanism further makes it possible to directly adapt the extension tube of the aerator to the inflation valve without relying upon any other nozzle for connection.

The foregoing object and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a perspective view of an inflation valve of the prior art.

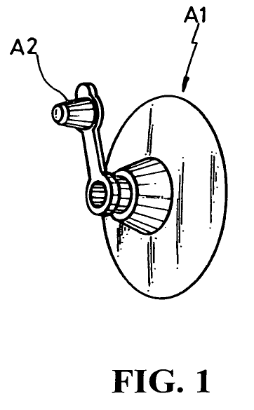

FIG. 2 is a perspective view of a preferred embodiment of the present invention.

FIG. 3 is an exploded view of the preferred embodiment of the present invention.

FIG. 4 is a sectional view showing the construction and operation of the preferred embodiment of the present invention.

FIG. 5 is another sectional view showing the construction and operation of the preferred embodiment of the present invention.

### DETAILED DESCRIPTION OF THE PREFERRED EMBODIMENTS

The following descriptions are of exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

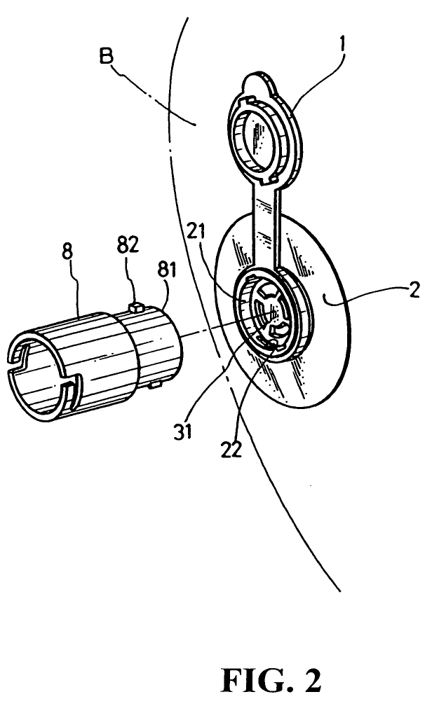

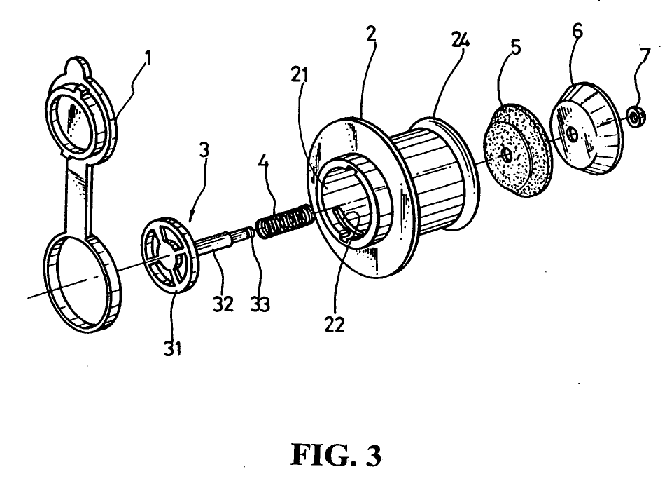

Referring to FIGS. 2 and 3, a valve of the present invention adapted to an inflated object (B) for inflation and deflation is essentially comprised of a foldable lid (1), a valve case (2), a displacement inner rod (3), a coil (4), a film bowl (5), a valve plug (6), and lock piece (7). Wherein, the lid (1) is inserted onto the outer circumference at the front of the valve case (2) to seal an inflation end (21) of the valve case (2); a locking slot (22) in symmetry and corresponding to the lid (1) is provided on the inner circumference at the front of the valve case (2) to receive the insertion of and incorporated with an extension tube (7) from an aerator.

The displacement inner rod (3) provides the mechanism of reciprocal operation of compressed displacement and by means of the coil (4) to return and to seal up the valve case (2). One end of the inner rod (3) is disposed with a hollowed press plate (31) and the other end related to a rod (32) topped with a nut (33) with the size of the press plate (31) merely matching that of the locking slot(22) of the valve case (2). The rod (32) and the nut (33) on the other end of the inner rod (3) penetrate through a central hole (231) of a hollowed support plate (23) disposed in the valve case (2) and then are secured together with the film bowl (5) and the valve plug (6) by means of the lock piece (7). The displacement inner rod effectively provides pivoting type of positioning mechanism.

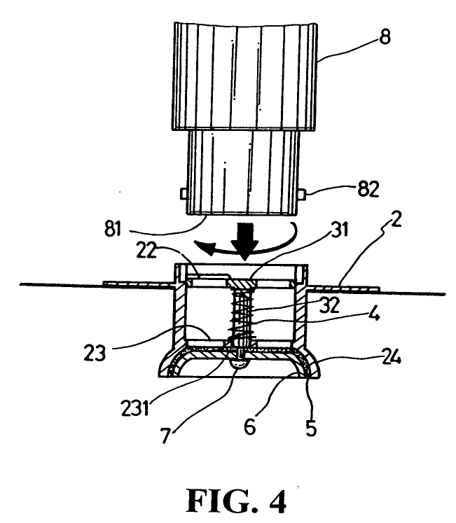

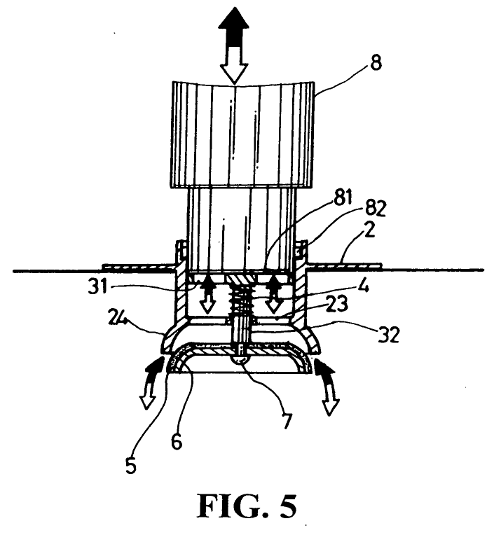

Now referring to FIG. 4, the tail of the valve case (2) indicates an internally inclined arc hollow body (24) to be sealed up by means of the valve plug (6) and the film bowl (5) covering up the valve plug (6) made in the same shape. Therefore, the hollow body (24) at the tail of the valve case (2) indicates open or shut-off circumferentially when the valve plug (6) is opened or shut off to expand its inflation or deflation capacity as illustrated in FIG. 5.

In terms of the relative locations between the inner rod (3) and the valve case (2) as illustrated in FIG. 5, the inner rod (3) is confined to the slot (22) of the valve case (2) to execute reciprocal displacement. Accordingly, when the press plate (31) is compressed, the inner rod (3) moves inwardly to open up the valve plug (6); on the contrary, when the press plate (31) is released from the compression, the inner rod (3) returns as being held against by the coil (4) to shut off the valve plug (6). In conjunction with a front end of an extension tube (8) from the aerator, the present invention achieves three purposes in one, respectively, the self-locking, inflation, and suction/drain.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. A self-locking inflation valve that can be locked up by turning into an extension tube from an aerator is essentially comprised of a foldable lid, a valve case, a displacement inner rod, a coil, a film bowl, a valve plug, and a lock piece; the circumference of an inner slot at the front of the valve case being disposed with a locking slot in symmetry and corresponding to the inner slot to engage the extension tube from the aerator, a hollowed press plate being disposed at one end of the inner rod, and the other end of the inner rod being comprised of a rod topped with a nut; the coil being inserted onto the rod; the hollowed press plate being disposed on the inner slot of the valve case; both of the rod and the nut on at other end of the inner rod penetrating through a central hole of a hollowed support plate disposed in the valve case and further through the film bowl and the valve plug to be secured in place by the lock piece; and both of the inner rod and the valve case providing the reciprocal type of pivoting structure mechanism.

2. The self-locking inflation valve of claim 1, wherein the foldable lid is inserted in position in the outer circumference of the front of the valve and seals up the inflation air inlet of the valve case when foldable inwardly.

3. The self-locking inflation valve of claim 1, wherein the tail of the valve case indicates an internally inclined arc hollow body; both of the valve plug and the film bowl covering up the valve plug are made in the same shape and both respectively are provided with an internally inclined arc peripheral; and the tail of the valve case is sealed up by the valve plug and the film bowl.

4. The self-locking inflation valve of claim 1, wherein the extension tube from the aerator is provided with a front end and a pin to execute the resistance type of self-locking by turning.
